(19) United States
(12) Patent Application Publication
(10) Pub. No.: US 2011/0313806 A1
(43) Pub. Date: Dec. 22, 2011

(54) ONLINE APPOINTMENT BOOKING SYSTEM

(76) Inventor: Ian Huang, Calgary (CA)

(21) Appl. No.: 12/817,395

(22) Filed: Jun. 17, 2010

(51) Int. Cl. G06Q 10/00

(52) U.S. Cl. 705/7.19

(57) ABSTRACT

This invention relates to an online booking system and method relating to same which can be used by any user, person, business, professional or facility. More particularly this invention relates to an on line calendar system and computer implemented method for online calendar appointments; embodiments of which can be used for example by, doctors, dentists, restaurants, barber shops, and the like. The person, business or professional sets up the calendar(s) online and users can book.

### FIELD OF INVENTION

This invention relates to an online booking system and method relating to same which can be used by any user, person, business or professional. More particularly this invention relates to an on line calendar system and computer implemented method for online calendar appointments; embodiments of which can be used for example by, doctors, dentists, restaurants, barber shops, and the like. The person, business or professional sets up the calendar(s) online and users can book appointments online.

### BACKGROUND TO THE INVENTION

Generally speaking every office or business requires a person to book appointments, which needs to be confirmed or verified. In today's society individuals are generally on the go and appointments are made, modified and confirmed at a rapid rate, requiring patience, time and cost. Furthermore there is generally a lag time between requesting an appointment time and having the time approved.

One such area where appointments are made is in the medical field where a patient or user needs to book appointment with a family doctor who may then subsequently require the patient to book an appointment with a specialist, hospital, blood lab, X-ray clinic or other scanning facility. It is not unusual for the patient to repeat basic information all over again. There have been various attempts to improve this scheduling issue.

For example U.S. Pat. No. 6,345,260 relates to a system and method for scheduling appointments at any time with a professional, such as a doctor, dentist, veterinarian, or the like, or a professional service, such as a medical testing facility and the like, even when the office of the professional or professional service is closed. The system and method relate to an asynchronous Internet, intranet, and extranet-compatible 24-hour appointment scheduling interface for making such appointments. As such, they support open-standards architecture, provide an interface for proprietary system architecture, permit off-line review and posting, permit access controls and virus protection, allow central scheduling without loss of distributed control, support encrypted messaging to ensure privacy, and include context-sensitive help. However such system requires booking agents and does not exhibit seamless internet booking.

Another arrangement is taught in US 2010/0070303 which shows a systems and method for aggregating available healthcare appointment times across multiple unaffiliated practitioner groups, including search and display algorithms. A centralized marketplace is provided for real time booking of healthcare appointments which does not require the patient to have a pre-existing relationship with the practitioner. The aggregated booking system enhances the number of available near term and conveniently located appointment options while the search and display algorithms reduce the complexity of the patient and practitioner information required to maintain accurate and synchronized database booking records. However this system is only a patient and client booking system with a dentist group.

Other arrangements are found in U.S. Pat. No. 767,449, U.S. Pat. No. 7,590,550, U.S. Pat. No. 7,188,073, US 2010/0076810.

It is an object of this invention to provide an improved online booking system and computer implemented method relating to same. It is a further object of the invention to provide a single centralised booking service for patients, clients, doctors, person, business or professional, facilities or clinics to make medical or general appointments in a registered facility, clinic, professional's, business's or doctor's office.

It is an aspect of this invention to provide A computer implemented method for booking appointments on line, comprising: generating a calendar identifying selected available appointment time periods; registering a user on line, with selected profile identifiers for accessing said calendar for booking an appointment.

Another aspect of this invention relates to an on line booking system, comprising: a server computer linked to the internet; a server application linked to the server computer, the server application being operable to provide instructions to the server computer that: receives profile information from a user for storage in global data base; permits registration by said user; receives profile information from a person, business or professional for storage in global data base; permits registration by said person, business or professional; receives information from a facility; permits registration by the facility; permits the facility to generate a calendar for appointment purposes; permits the registered user to access the calendar to make an appointment.

These and other objects and features of the invention shall now be described in relation to the following drawings. The drawings are for illustration purposes and show several embodiments of the invention.

### DESCRIPTION OF THE DRAWINGS

FIG. 1 illustrates a general flowchart for Facility, Doctors, Patients, and Calendars.

FIG. 2 illustrates a Patients Flowchart with Each Facility.

FIG. 3 illustrates Patient Booking Appointments.

FIG. 4 shows Doctor A appointment for Patient D with Doctor A.

FIG. 5 illustrates Doctor C Booking Appointment for Patient E with Doctor A in the same Facility 2.

FIG. 6 illustrates Doctor B Facility 3 Booking appointment for Patient D with Doctor C in another Facility 2.

FIG. 7 illustrates that when a patient arrives at a clinic the patient can check in with the receptionist or check in on a self serve basis using the patient kiosk.

FIG. 8 illustrates Walk in Appointments.

FIG. 9 illustrates messaging.

FIG. 10 illustrates Build/Edit Calendar

FIG. 11 shows a Kiosk Home page.

FIG. 12 shows a Kiosk page after patient login.

FIG. 13 shows message settings.

FIG. 14 shows a template to manage doctors.

FIG. 15 illustrates a Linking of a Facility to another facility.

FIG. 16 shows a Build/Edit/Delete time slot template for a Calendar.

FIG. 17 shows a Manage Employees template.

FIG. 18 shows an off days template.

FIG. 19a illustrates a recall Patients template.

FIG. 19b illustrates a Result codes.

FIG. 20 shows a Facility registration

FIG. 21 comprising FIG. 21a, 21b shows a Doctor registration template.

FIG. 22 comprising FIG. 22a, 22b, 22c illustrates a Patient's Registration template.

FIG. 23 comprising FIG. 23a, 23b shows a Facility registering a new patient.

FIG. 24 shows a template for a Patient to add a new family member.

FIG. 25 shows a Patient/Client (User) switching to book appointments with different categories or types of business.

FIG. 26 shows Editing Family Members

FIG. 27 shows Building Appointment Types for Time Slots

FIG. 28 comprising FIG. 28a, 28b shows multiple calendars automatically displayed with the calendars in use for the day chosen

FIG. 29 shows when a patient arrives in the clinic for an appointment, the receptionist or the patient can check in with the time recorded.

FIG. 30 shows a flow chart for a Patient registration on line.

FIG. 31 shows a flow chart for a Facility Registration on line.

FIG. 32 shows a flow chart for a Doctor Registration on line.

FIG. 33 illustrates a flow chart for a Patient booking Appointment on line.

FIG. 34 illustrates a Facility Booking Appointment for Patient on line.

FIG. 35 depicts a flow chart for a Doctor Booking Appointment for Patient on line.

FIG. 36 shows a flow chart for adding a patient to a facility's local patient data base.

FIG. 37 depicts a flow chart for linking one facility to another facility.

FIG. 38 illustrates a flow chart for a doctor adding his account to a facility to be a provider.

### DETAILED DESCRIPTION OF THE INVENTION

The invention shall now be described in the context of the drawings.

### Registration:

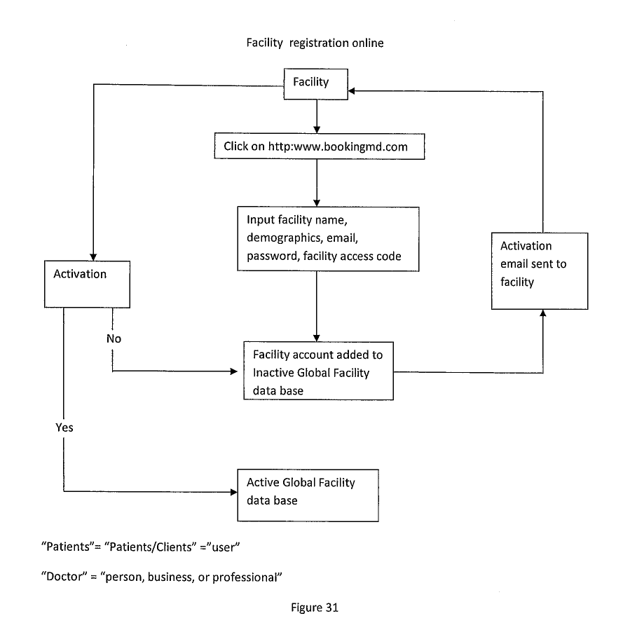

1. Facility Registration—FIG. 31:
One embodiment of the facilities registration component is shown in FIG. 31. A facility such as a business or professional or hospital or clinic can register on line. The person, business or professional first registers online. The person, business or professional can first set up a facility such as a clinic or business as shown

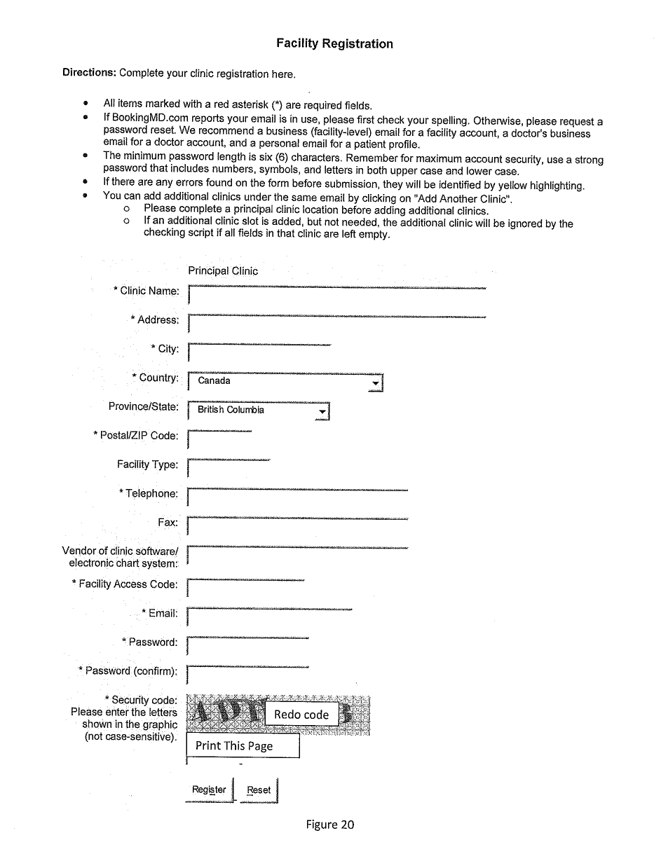

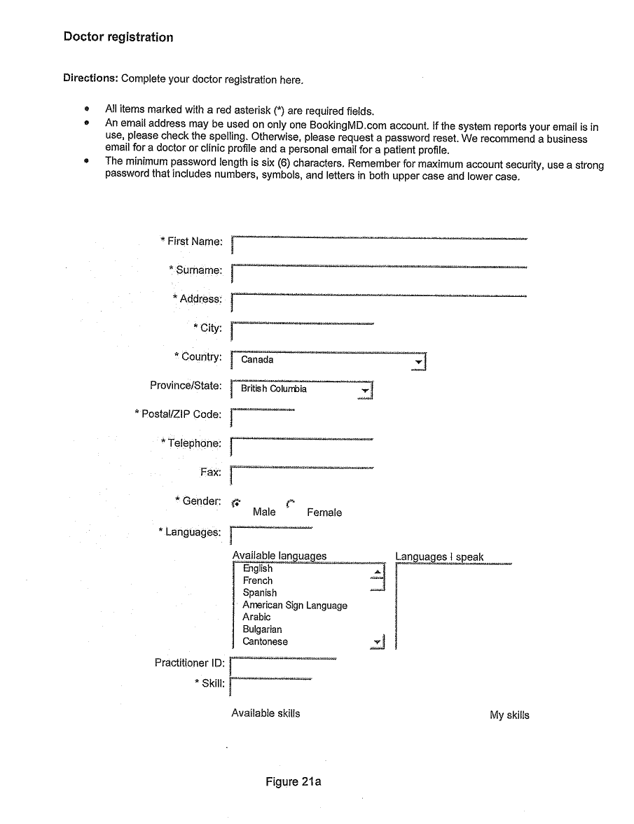

FIG. 20. Additional facilities such as clinics or businesses can be set up to take into account a person, business, professional or doctor having more than one clinic. Any facility can be linked to other facilities to link for example franchise businesses or a person having more than one business. Other facilities can set up on their own and be linked to other facilities. Facilities can also be unlinked from other facilities. A facility only can change its own private profile information.

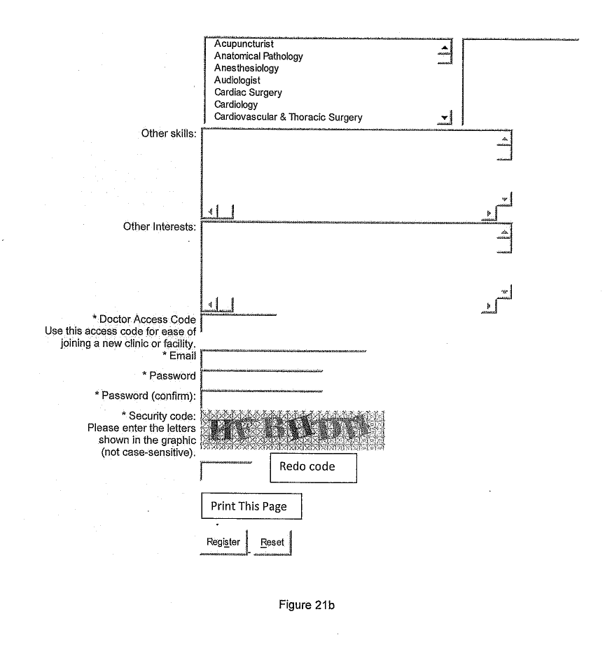

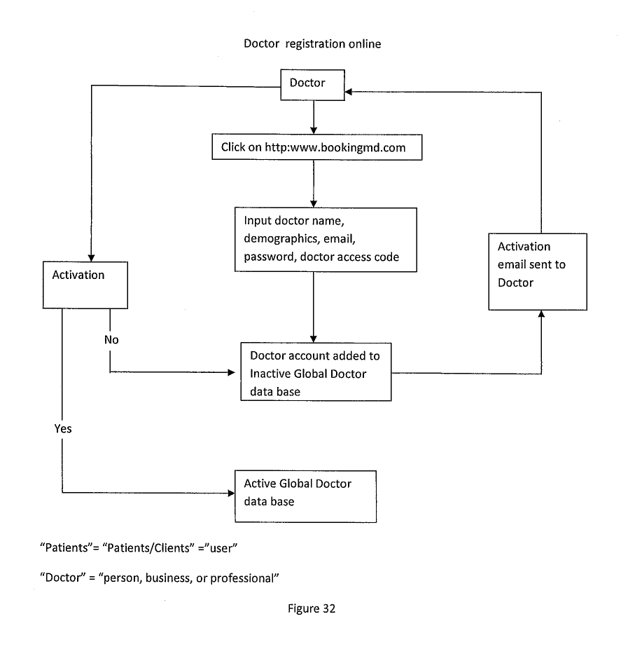

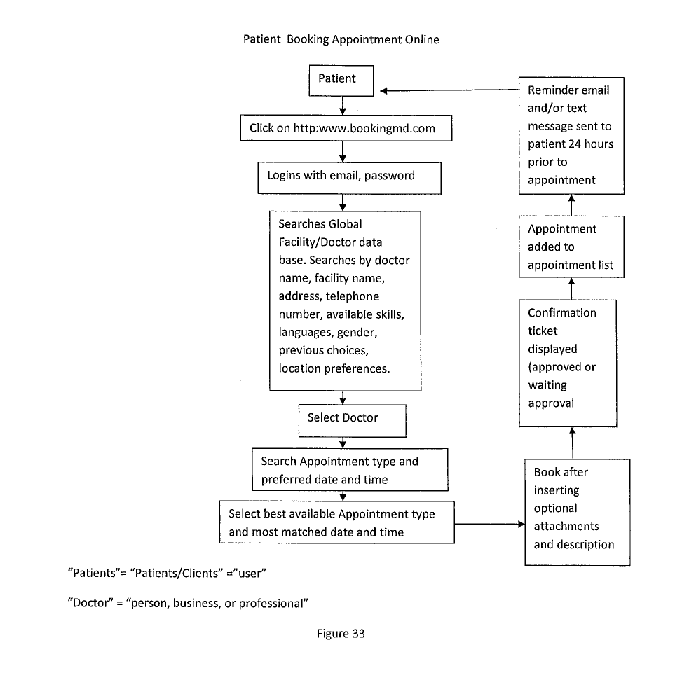

2. Person, Business, Professional or Doctor Registration—FIG. 32:
One embodiment of a person, business, professional or doctor registration is shown in FIG. 32. A person, business or professional can also can register online an example of which is shown in FIG. 21 and join or be linked to one or more facility such as a clinic or business as shown in FIG. 14. For example, a doctor can register and then he can join or be linked to one or more facilities where the works. The person, business or professional can also be unlinked from a facility such as a clinic or business. A person, business or professional can change its own private profile information.

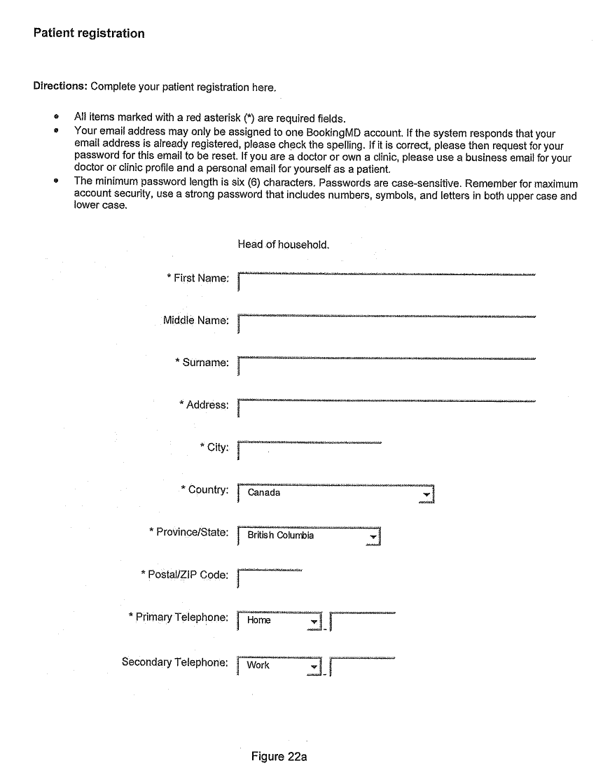

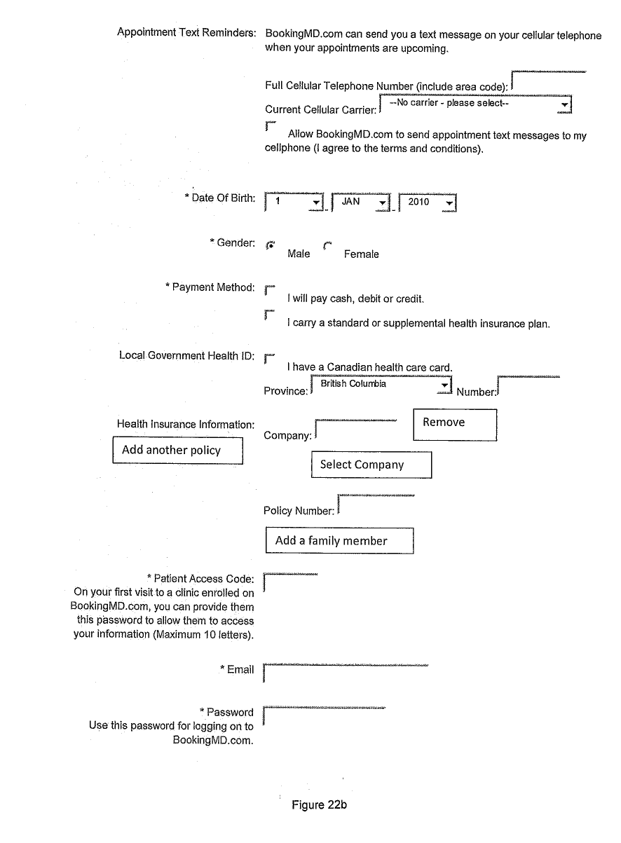

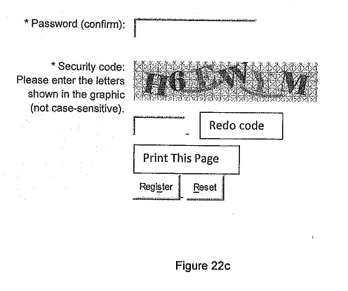

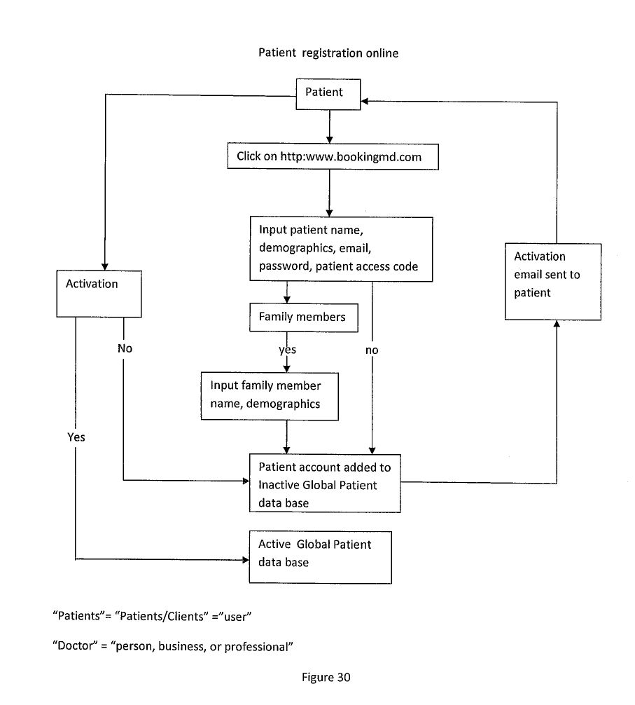

3. Patient/Client Registration—FIGS. 22 & 30:
Both FIGS. 22 and 30 illustrate a patient or client registration. A user who registers and sets up an account will enter their account into the Global Patient/Client (User) database such as a Global Patient/Client (User) account. A user who books an appointment with a facility (clinic or business) with its people, business or professional, adds their Global Patient/Client (User) account (FIG. 22) to the facility's list of users/client/patients (Local Patient/Client (User) data base). A user can be enrolled in one or more facilities. The patient/client (user) account will be entered into each facility's Local Patient/Client (User) data base.
An email is the unique identifier for the patient's or client's (user's) account when he or she registers. A password is also needed. The account is entered into the Global Patient/Client (User) data base.
Registration information can include name, address, telephone number, cellular number, fax number, email address, languages, skills, access codes to allow changes to the registration information by others or for ease of joining another online facility (clinic or business) or for enrolment in a facility (clinic or business) to allow them to access information such as date of birth, gender and/or other personal information such as local government health identification, health insurance company, health insurance policy number, credit card number, social insurance number etc.

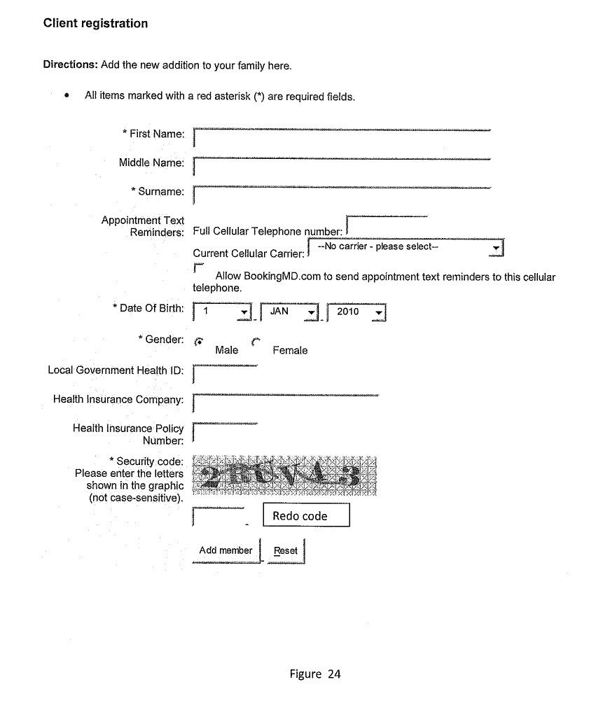

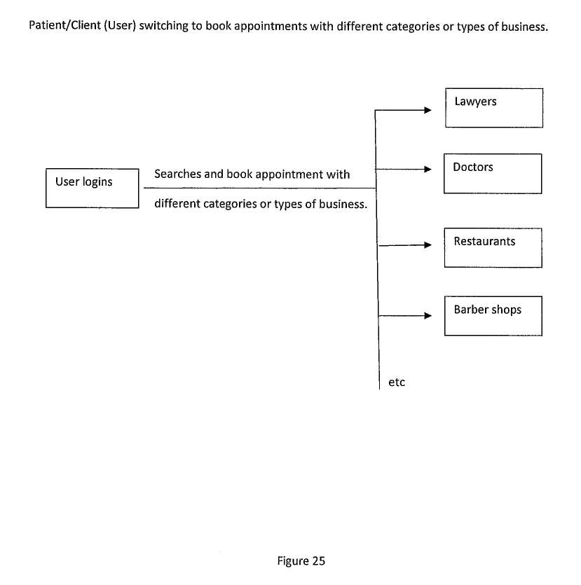

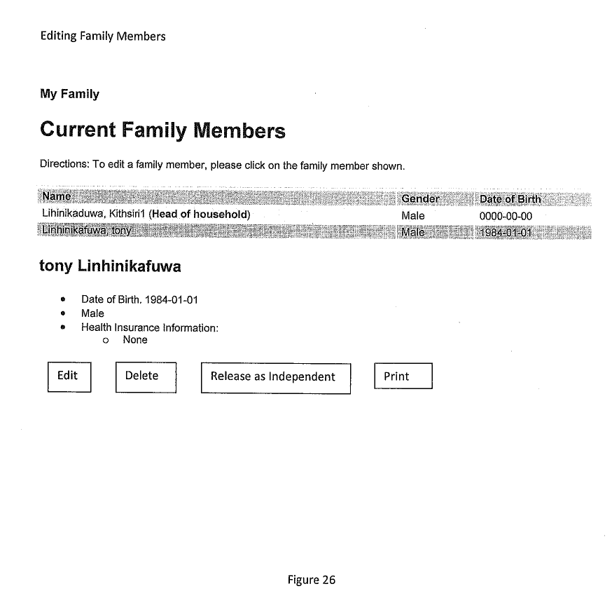

4. Family Dependent Registration—FIG. 30:
As shown in FIGS. 30 and 24 a user can add or register family members to their account or profile by providing the necessary information. A family member can be edited, deleted, or released as an independent as referred to in FIG. 26.
When a family member is released as an independent, all past information is not seen by the independent. All future information for the independent is not seen by anyone except by the independent.

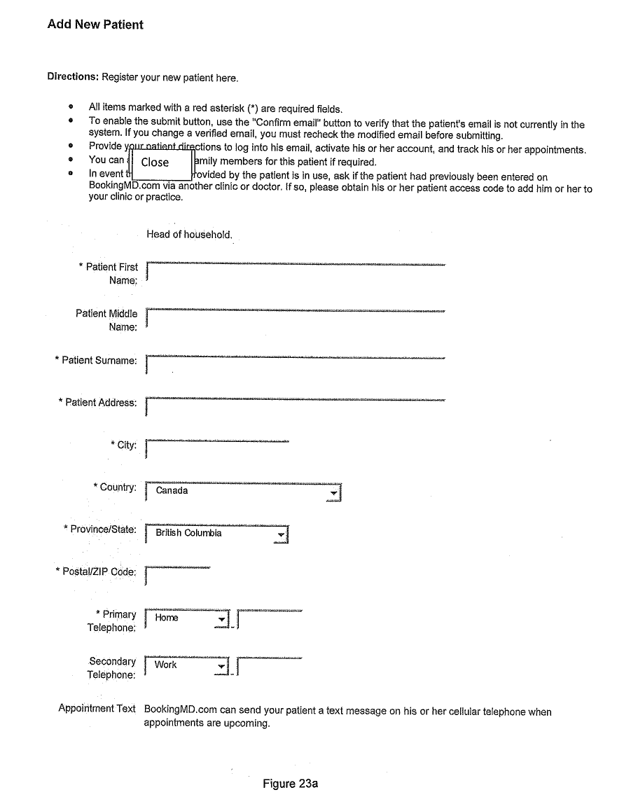

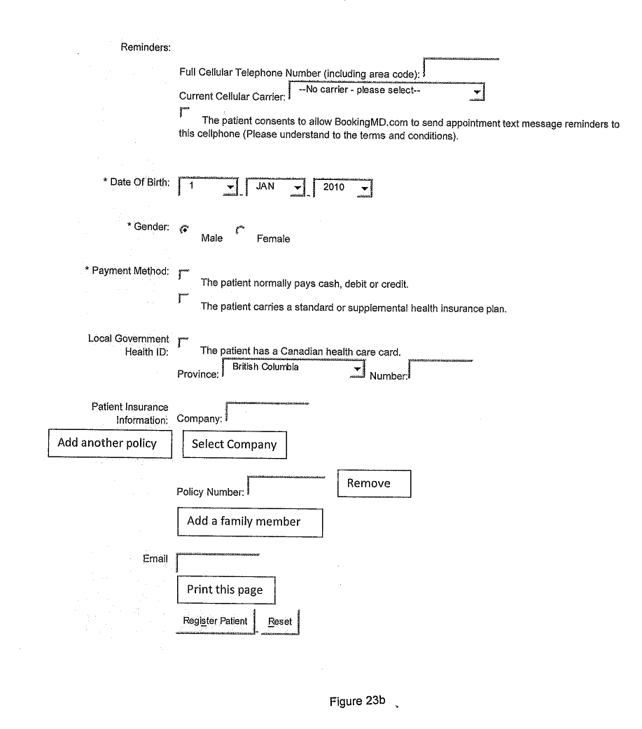

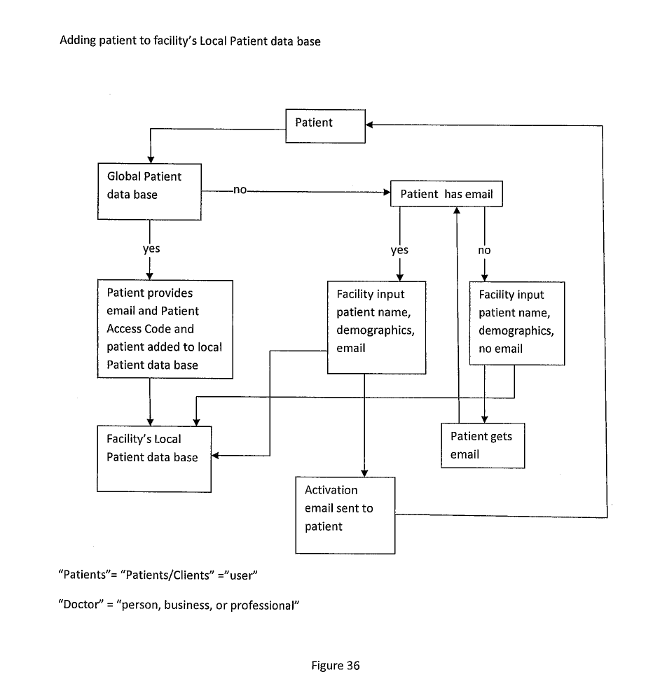

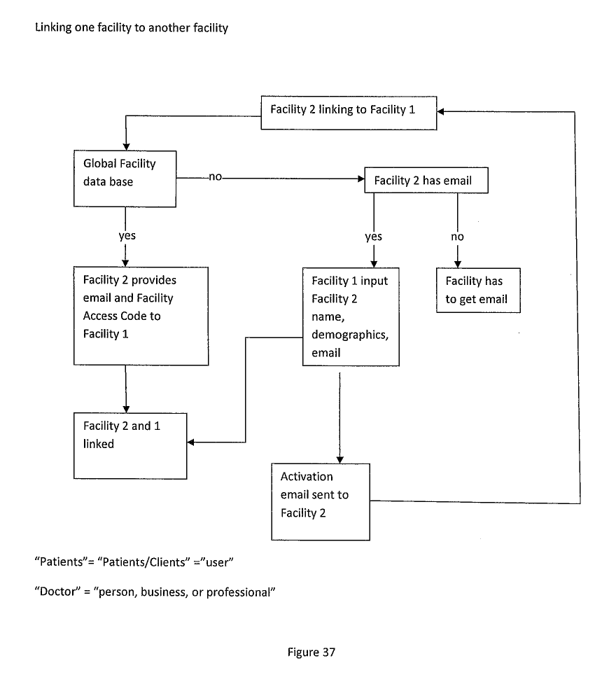

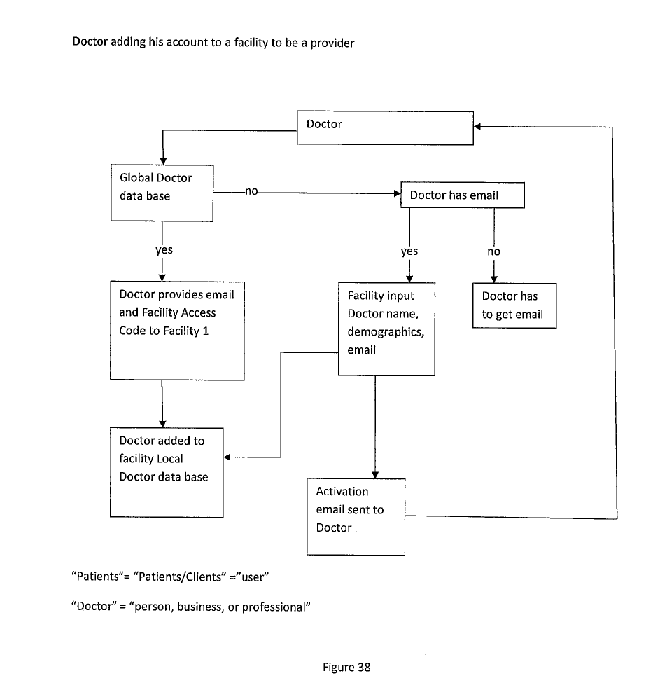

5. Facility Registering Patient/Client With Unique Email—FIG. 36:
A facility or a person, business or professional can register a user as shown in FIG. 23. An email for each patient/client (user) is the unique identifier for the patient's global patient/client (user) account. An email, text or other means of contact is sent to the user. The user can activate his or her account, assign a password and user access code. Once a user activates his account, only the user can change his email address, unless he gives his user access code to a facility, person, business or professional to change his email. All other registration information may be changed by the user, and user linked facility, person, business or professional. An email or text is sent to the user whenever there are changes to the registration information. Before activation of the account, a facility, person, business or professional who has the user's registration information can change the registration information.
Registration information can include name, address, telephone number, cellular number, fax number, email address, languages, skills, access codes to allow changes to the registration information by others or for ease of joining another online facility (clinic or business) or for enrolment in a facility (clinic or business) to allow them to access information such as date of birth, gender and/or other personal information such as local government health identification, health insurance company, health insurance policy number, credit card number, social insurance number and the like.

6. Facility Registering Patient/Client With No Email—FIG. 36:
If a patient/client (user) does not have a personal email, a facility or a person, business or professional can still register a user. In this case with respect to FIG. 23 the patient's or client's (user's) account or profile stays only in the facility's Local Patient/Client (User) data base. When the patient/client (user) obtains an email, then the email can be given to the facility to update the patient's or client's (user's) Local Patient/Client (User) account and an email, text or other means of contact is sent to the user. The user can activate his or her account, assign a password and user access code. Once a user activates his account, only the user can change his email address, unless he gives the user access code to a facility, person, business or professional to change his email. All other registration information may be changed by the user, and user linked facility, person, business or professional. An email or text is sent to the user whenever there are changes to the registration information. Before activation of the account, a facility, person, business or professional who has the user's registration information can change the registration information.
If the patient/client (user) registers and creates a Global Patient/Client (User) account, then he provides the email to the facility to merge his facility's Local patient/ client (user) account into the Global Patient/Client (User) account.

7. Facility Adding Patient/Client (User) with Global Patient/Client (User) Account—FIG. 36:
If the patient/client (user) registers and creates a Global Patient/Client (User) account, then he provides the Global Patient/Client (User) account to the facility to add his Global Patient/Client (User) account to the facility's list of patients or clients (Users) (Local Patient/Client (User) data base).

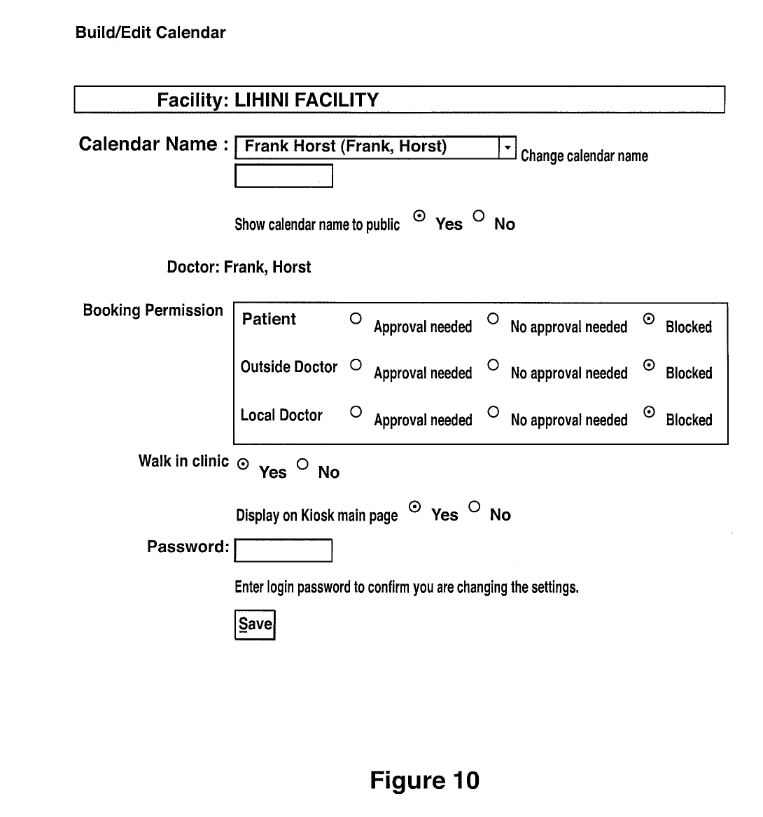

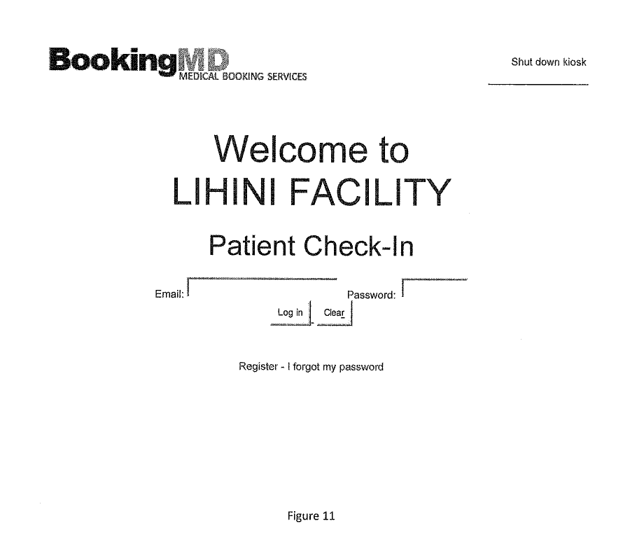

### Calendar—FIG. 10:

The facility, person, business or professional can set up the calendars by assigning a title or name for each calendar assigned for appointment booking. The title or name can be changed at any time. The calendar name can be set to be visible or not visible to the users. A calendar is done for a specific business booking and can be linked to specific facility (clinics or businesses). For each calendar, the business can change appointment booking settings of whether the business wants to confirm whether or not an appointment booking needs to be approved first. The business can also block access to book appointments by the general users, outside businesses or inside the business itself. So for example if a doctor wants to block appointment booking by patients, he would click on “Blocked” for patients and patients cannot book appointments with him. Furthermore, if the doctor decides to take appointments from patients, he can decide if the appointment first must be approved “Approval Needed” by the doctor or if not “No Approval Needed”as shown in FIG. 10. If the doctor chooses “Approval Needed”, then the appointment chosen by a patient is not booked until it is confirmed by the doctor. If the doctor chooses “No Approval Needed”, then the appointment chosen by a patient is booked automatically when chosen by the patient and no approval is needed by the doctor.

The facility, person, business or professional can set up a calendar to take walk in appointments. The walk in appointments are based on first come first serve basis. The walk in calendar can be set to be displayed on the patient/client (user) access kiosk. The display may be on a computer screen or digital screen or the like.

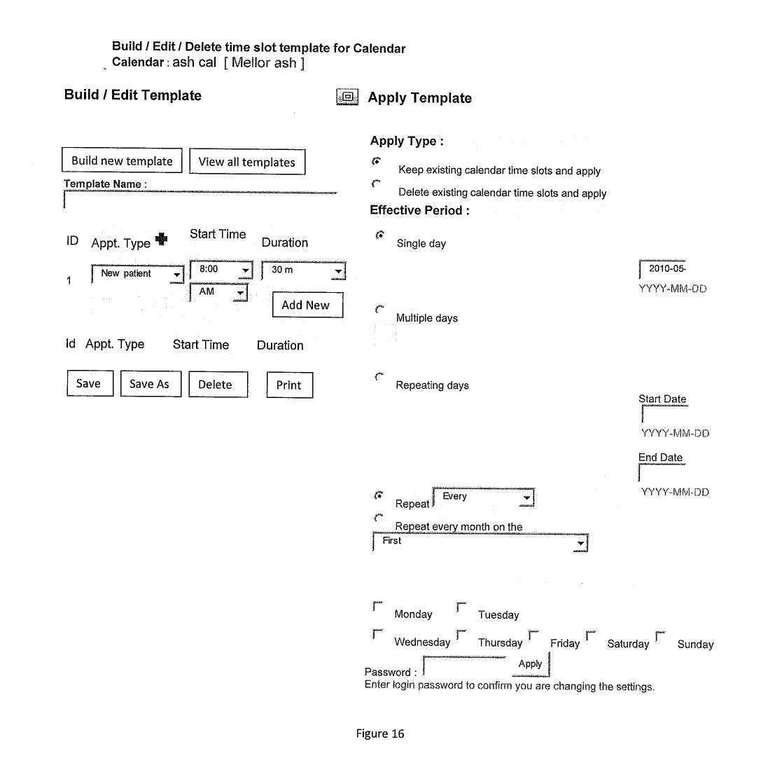

### Building a Calendar—FIG. 16:

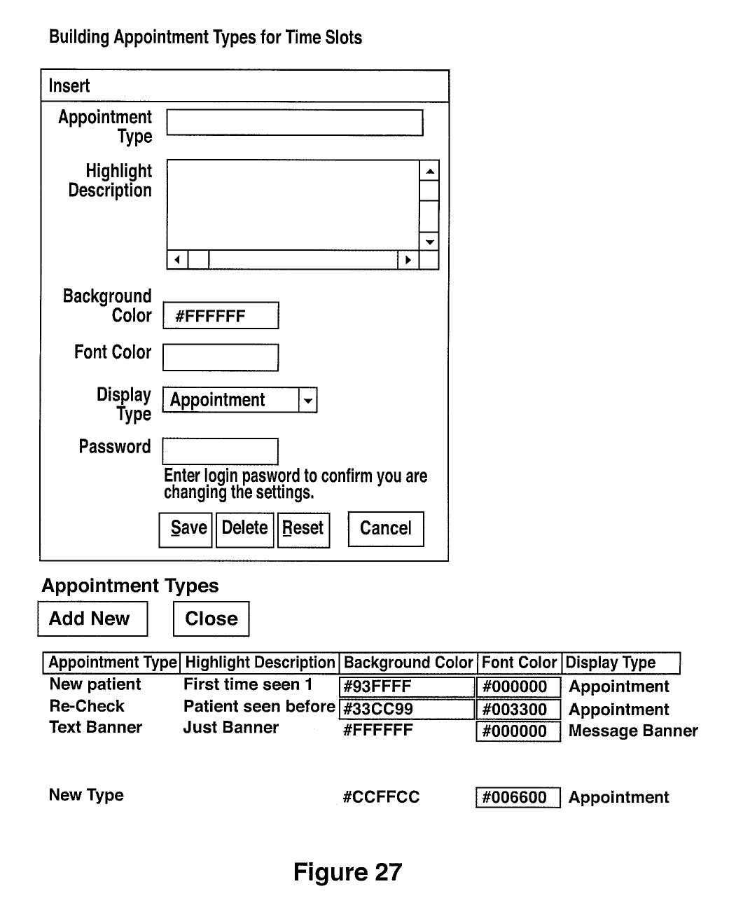

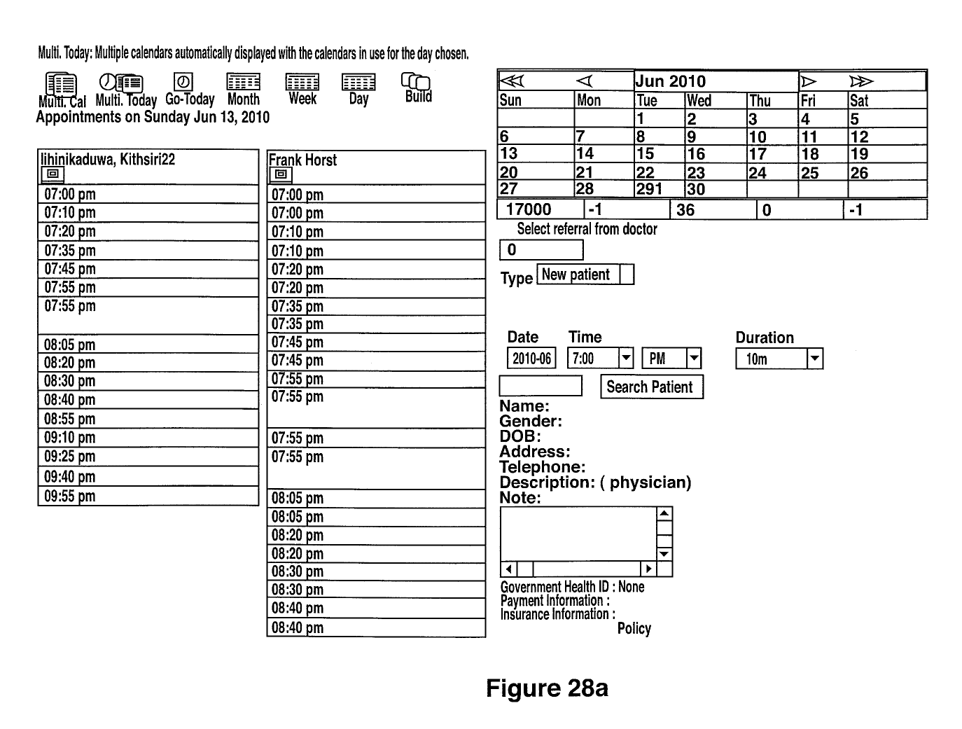

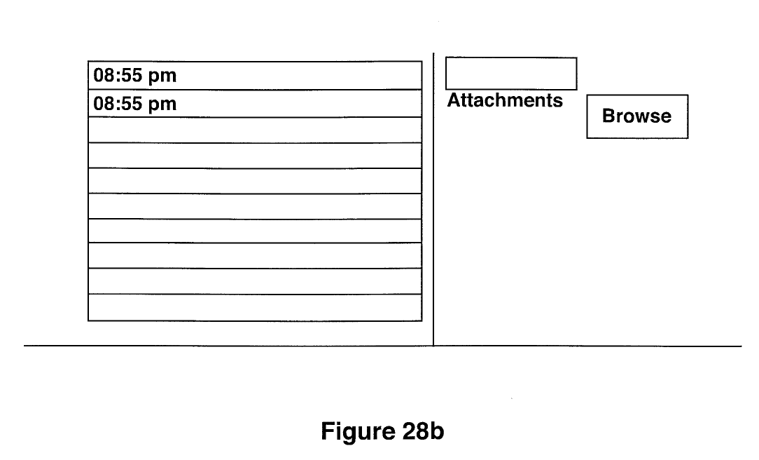

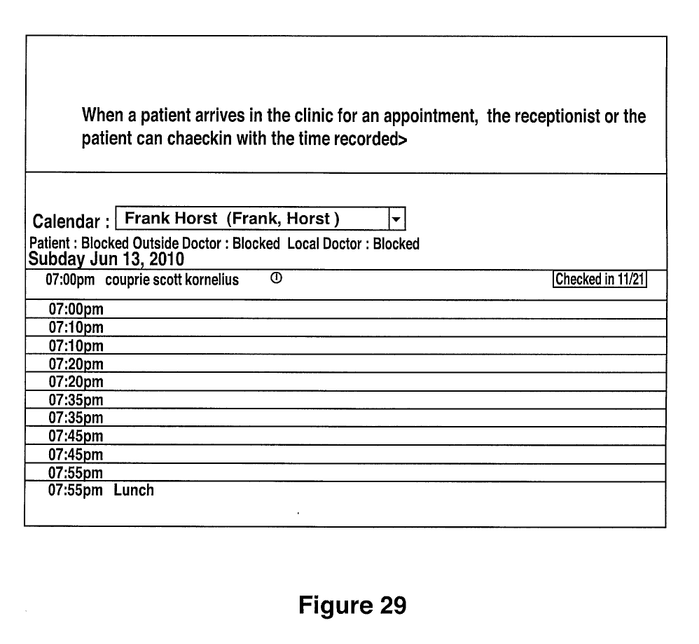

A calendar can be built with the following:
1. Time Slots—FIGS. 27 and 16:
Time slots can be assigned “appointment type name”, “highlight description”, background color, font color, duration. The start time and duration for each time slot is specified. A time slot or time period can be set for taking appointments on a walk in first come first serve basis. Time slots can be prepared for any desirable time interval such as for example 3 minute time slots.
2. Templates:
Once time slots have been built to create a template, a template name can be assigned. The templates can be saved for later use. A saved template can be edited and saved under another template name. A template with its time slots can be added to existing calendar time slots or the existing calendar time slots can be deleted and the new template applied. Times slots can be added to a calendar without creating a template or assigning a template name.
The templates can be applied to a specified single day, multiple days or repeating days with a start date and end date.
3. Viewing Calendar:
The calendar can be viewed with
1. Multiple calendars displayed at once. The multiple calendars are assigned a name to define each multiple calendars set.
2. Multiple calendars automatically displayed with the calendars in use for the day chosen—FIG. 28.
3. By the month
4. By the week
5. By the day

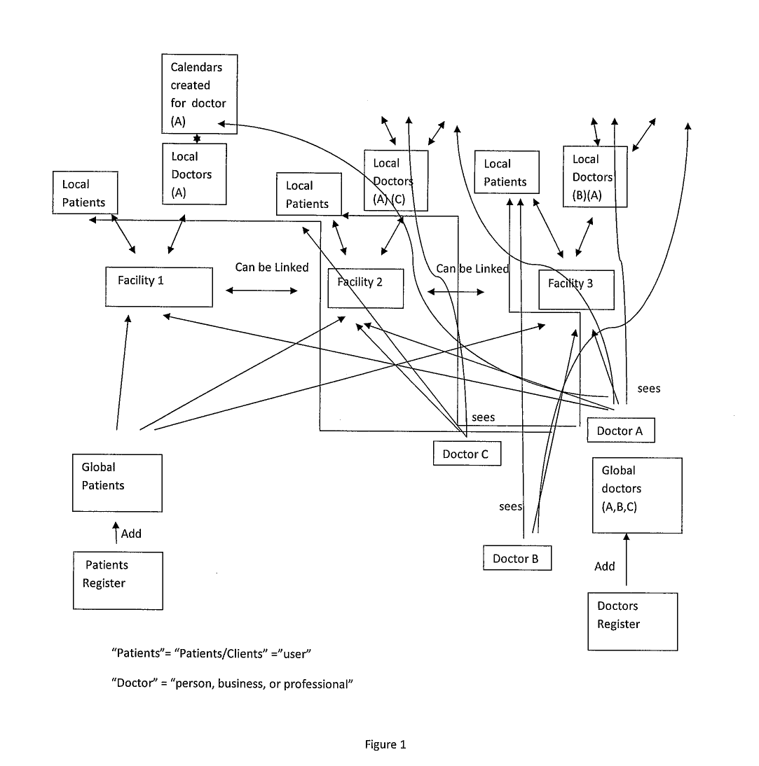

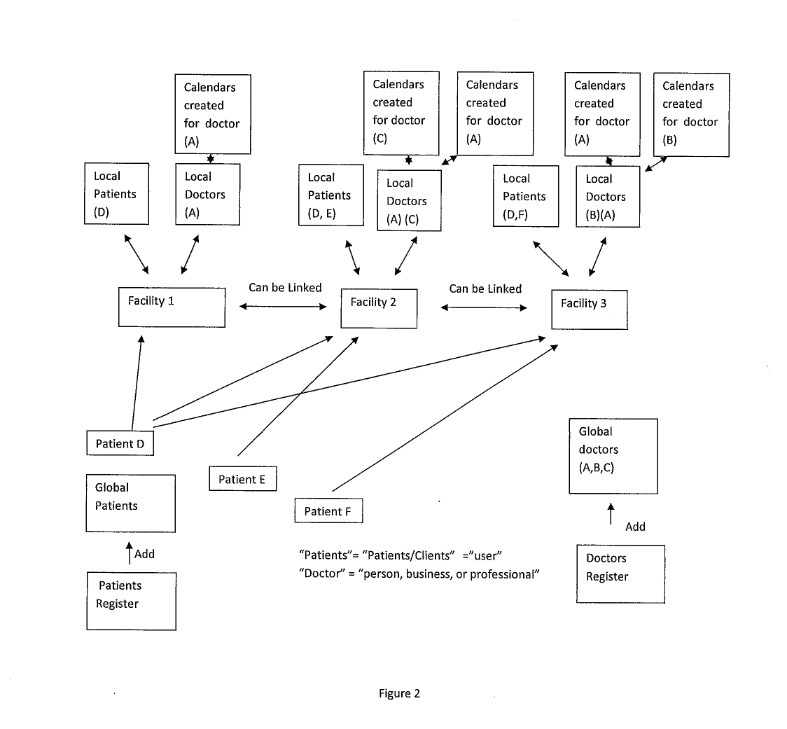

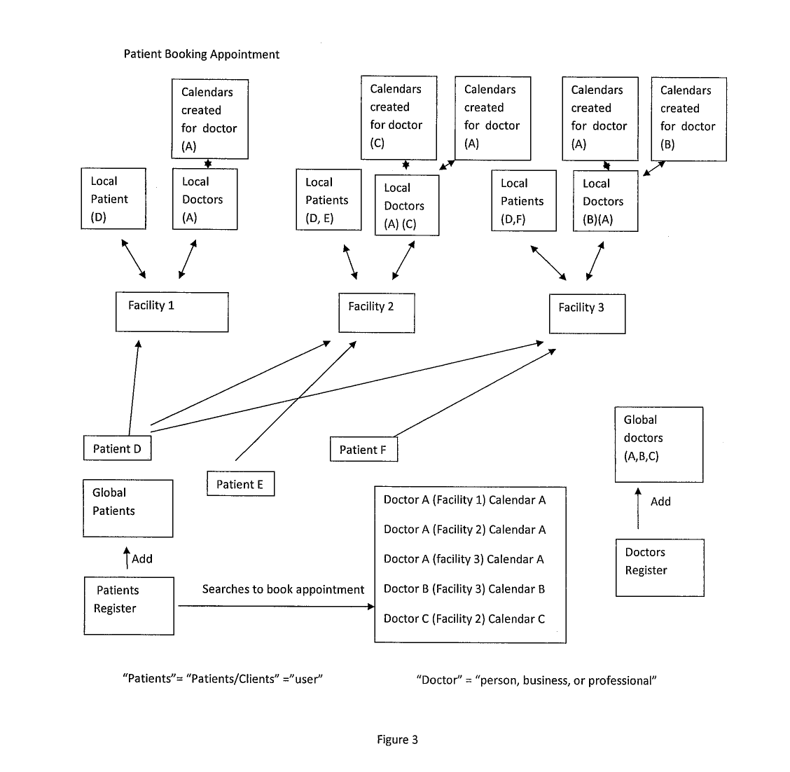

### Add Users—FIG. 1:

1. A user can register and create an online account and profile which are stored at the central computer (Global Patient/Client (User) profile) FIG. 30. When a user desires to add the users Global Patient/Client (User) profile to a facility's (clinic or business) list of local users (Local Patient/Client (User) data base), the user can provide the facility (person, clinic or business) with the user's email address and user access code. The facility (person, clinic or business) can then access the user's profile at anytime. Once a user's profile is in the Global Patient/Client (User) profile, it can be edited or updated only by the user. A facility (person, clinic or business) can edit or update certain information in a user's global profile only if the user gives the facility (person, clinic or business) the user's access code. The user may restrict what information can be changed by others even with the access code.

2. A facility (clinic or business), person, business, or professional can register and create an online account and profile for a user by filling the registration form for the user. An email is sent to the user at his email address. The user activates the account when he opens his email and activates the account. The user can then add an access code. Once a user's profile is activated, it is in the Global Patient/Client (User) database, certain registration information can be edited or updated only by the user and no one else. A facility (clinic or business), person, business or professional can edit or update certain aspects of information in the user's Global Patient/Client (User) profile only if the user gives the facility (clinic or business,) person, business or professional the user's access code. A facility (clinic or business), person, business or professional can edit or update certain aspects of information in the user's Global Patient/Client (User) profile without the user's access code.

3. The facility (clinic or business), person, business or professional keeps a list of users who are its customers (Facility Local Patients/Clients) (User). The facility (clinic or business), person, business or professional cannot access users who are not its customers in the Global Patient/Client (User) data base.

### Add Facilities (Clinics or Businesses)—FIGS. 1, 15 & 37):

1. A facility “2” (clinic or business) can register and create an online account and profile which are stored at the central computer (Global Facility data base). When a facility “2” (clinic or business) wants to be linked its Global Facility profile to another facility “1”'s (clinic or business) list, the facility “2” (clinic or business) can provide the facility “1” (clinic or business) with its email address and facility access code. The facility “1” (clinic or business) can then be linked to facility “2” (clinic or business) and to its list of providers. Other additional facilities can be added.

2. A facility “1” (clinic or business) can register and create an online account and profile for facility “2” (clinic or business) by filling the registration form for the facility “2” (clinic or business). An email is sent to the facility “2” (clinic or business) at its email address. The facility “2” (clinic or business) activates the account when it opens its email and activates the account. The facility “2” can then add its facility access code.

3. A facility can be unlinked from another facility at any time.

Add person, Business or Professional—FIGS. 1, 14 & 38:

1. A person, business or professional e.g. (A, B, C) can add its account to a facility or multiple facilities.

2. A person, business or professional can register and create an online account and profile which are stored at the central computer (Global Person, Business, Professional, or Doctor profile). When a person, business or professional wants to add its Global Person, Business, Professional or Doctor profile to a facility (clinic or business), it can provide the facility with its email address and Person, Business, Professional or Doctor access code. The facility (clinic or business) can then add the person, business or professional to its list of providers (Local Person, Business, Professional or Doctor data list).

3. A facility (clinic or business) can register and create an online account and profile for person, business or professional by filling the registration form for the person, business or professional. An email is sent to the person, business or professional at its email address. The person, business or professional activates the account when it opens its email and activates the account. The person, business or professional can then add a Person, Business, Professional or doctor access code.

4. Appointment calendars for the person, business or professional are then listed under the facility or facilities which the person, business or professional are enrolled in. Users can then search and access the calendars and make appointment online.

5. The facility and person, business or professional can be unlinked from each other at any time.

### Appointments:

1. Booking Appointments:

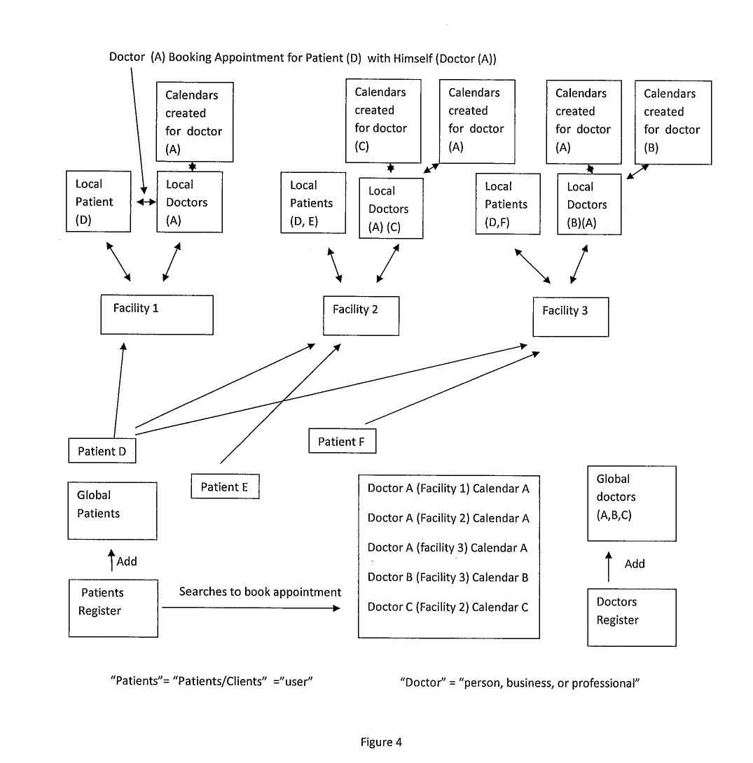

A) Users Booking Appointments (FIG. 3 & 33):
A user can book appointment with a facility (clinic or business) and its associated person, business or professional and a specific calendar by searching for the calendar (person, business or professional)/facility by name, telephone number, address, gender, languages, skill or professional and other clinic or business information. Search preference can be by international, country, region or local area. The user search for an available time slot is based on the user's choice of type of appointment date and time. If a time slot is available on the calendar (person, business or professional)/facility then the user can book the appointment. The user can add attachments, letters, description or notes. The attachment, letters and description are sent to the clinic or business, the notes are not. Notes are viewed by the user only. A confirmation ticket is generated with “approved” or “waiting approval” status. Standard templates can be created for the description and used at another time. A printout in the form of a letter can be generated with the names of the referring person, the referred to person and demographics of the user. Emails are generated to inform the user and facility of the appointment. Reminder emails or texts are sent at a predetermined time to tell the user of his upcoming appointment or if there are any changes to the appointments. Notes about each appointment can be added and viewed by the user only.
Users can search for and book appointments with different categories or types of businesses. For example, a user can book with a doctor or switch to book with a barber shop or switch to book with a lawyer.
Appointment List:
A user can view his past or current appointment.

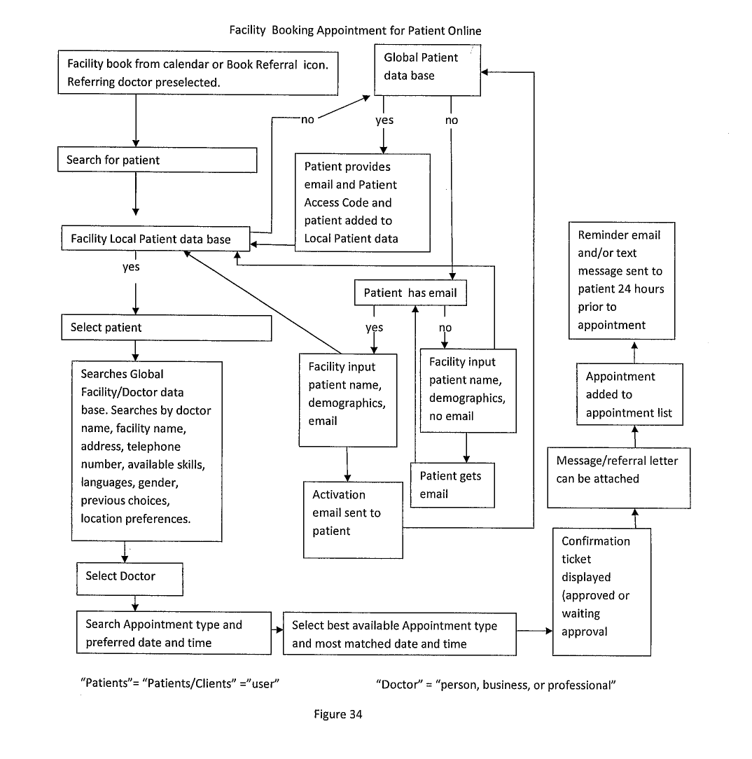

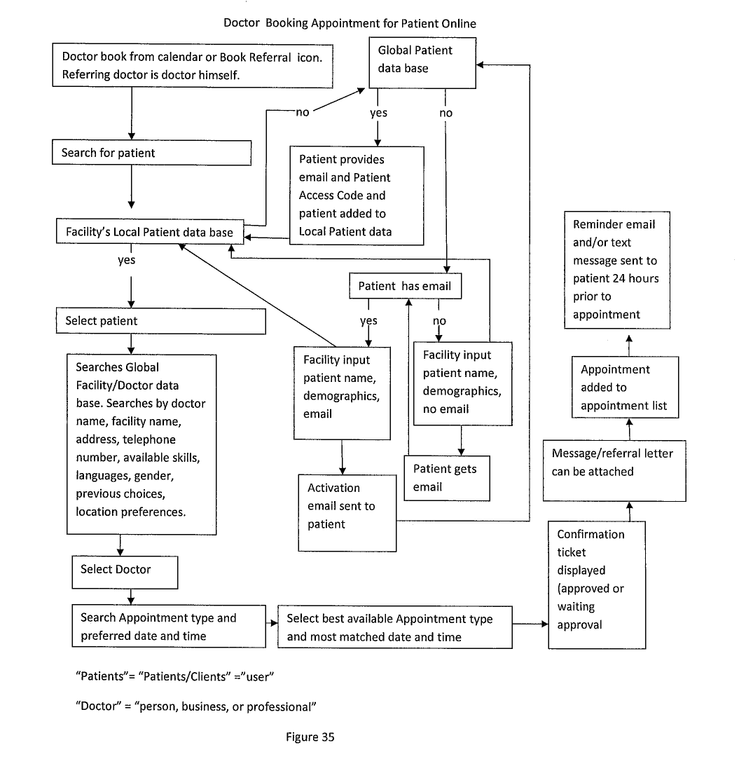

B) Facility (Clinic Or Business) Booking Appointments—FIG. 34:
A facility (clinic or business) can book an appointment for a user with the same facility or outside facility, with the same person, business or professional or with an outside person, business or professional or person, business or professional/facility combination by searching for the person, business or professional, facility name, calendar name, telephone number, address, gender, languages, skill or professional and other person, business or professional/facility information. Search preference can be by international, country, region or local area. The facility (clinic or business, person, business or professional searches for an available time slot based on the user's choice of type of appointment date and time. If a time slot is available on the (person, business or professional)/facility calendar then the facility can then book the appointment for the user. The facility (clinic or business), person, business or professional can add attachments, letter, description or notes. The attachments, letters, and description are sent to the facility (clinic or business), the notes are not. Notes are viewed by the referring facility (clinic or business), person, business or professional only. A confirmation ticket is generated with “approved” or “waiting approval” status. Standard templates can be created for the description and used at another time. A printout in the form of a letter can be generated with the names of the referring person, referred to person and demographics of the user. Emails are generated to inform the user and facility of the appointment. Reminder emails or text are sent at a predetermined time to tell the user and facility of his upcoming appointment or if there are changes to the appointments. Notes about each appointment can be added and viewed by the referring facility (clinic or business) only.
A facility can search for and book appointments for a user with different categories or types of businesses. For example, a facility can book appointment for a user with a doctor or switch to book appointment for a user with a barber shop or switch to book appointment for a user with a lawyer.
From the calendar, a referred to person can generate a reply letter to the referring person or the user with the referred to person, referred from person and user names generated automatically and the standard templates inserted to form a letter.

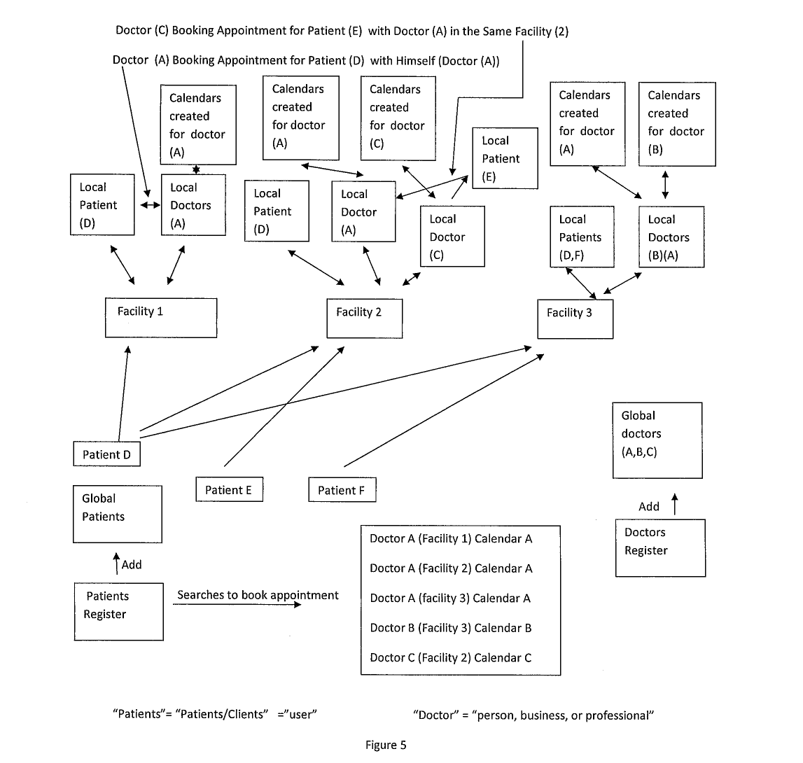

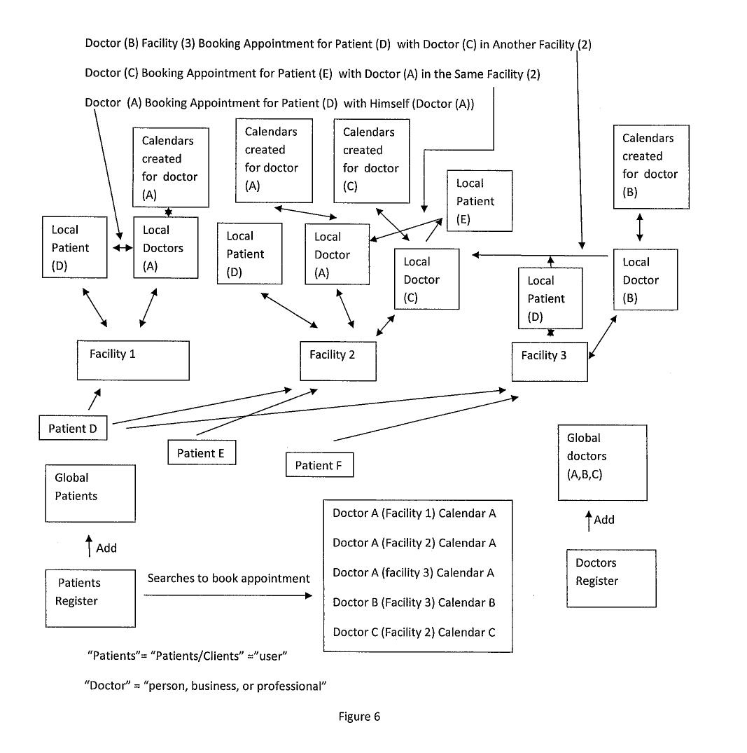

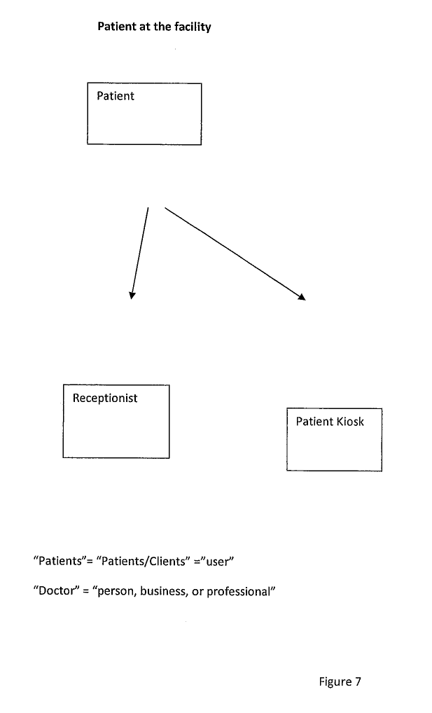

C) Person, Business or Professional Booking Appointments—FIGS. 4, 5, 6 & 35:
A person, business or professional can book appointment for a user with the same facility or outside facility, with the same person, business or professional or with an outside person, business or professional or person, business or professional/facility combination by searching for the person, business or professional, facility name, calendar name, telephone number, address, gender, languages, skill or professional and other person, business or professional/facility information. Search preference can be by international, country, region or local area. The person, business or professional searches for an available time slot based on the user's choice of type of appointment date and time. If a time slot is available on the (person, business or professional)/facility calendar then the person, business or professional can then book the appointment for the user. The person, business or professional can add attachments, letters, description or notes. The attachments, letters, and description are sent to the facility (clinic or business), person, business or professional, the notes are not. Notes are viewed by the referring facility (clinic or business), person, business or professional only. A confirmation ticket is generated with “approved” or “waiting approval” status. Standard templates can be created for the description and used at another time. A printout in the form of a letter can be generated with the names of the referring person, referred to person and demographics of the user. Emails are generated to inform the user and facility of the appointment. Reminder emails or text are sent at a predetermined time to tell the user and facility of his upcoming appointment or if there are changes to the appointments. Notes about each appointment can be added and viewed by the referring person, business or professional only.
A person, business or professional can search for and book appointments for a user with different categories or types of businesses. For example, a person, business or professional can book appointment for a user with a doctor or switch to book appointment for a user with a barber shop or switch to book appointment for a user with a lawyer. From the calendar, a referred to person can generate a reply letter to the referring person or the user with the referred to person, referred from person and user names generated automatically and the standard templates inserted to form a letter.
Appointment List:
A person, business, professional or facility (clinic or business) can view its past or current appointments
List of Appointment to be Approved:
A list is kept for the person, business, professional, or facility (clinic or business) to approve.

2. Booking Permission—FIG. 10:
For each calendar, the business can change appointment booking settings of whether the business wants to confirm whether or not an appointment booking needs to be approved first. The business can also block access to book appointments by the general users, outside businesses or inside the business itself.

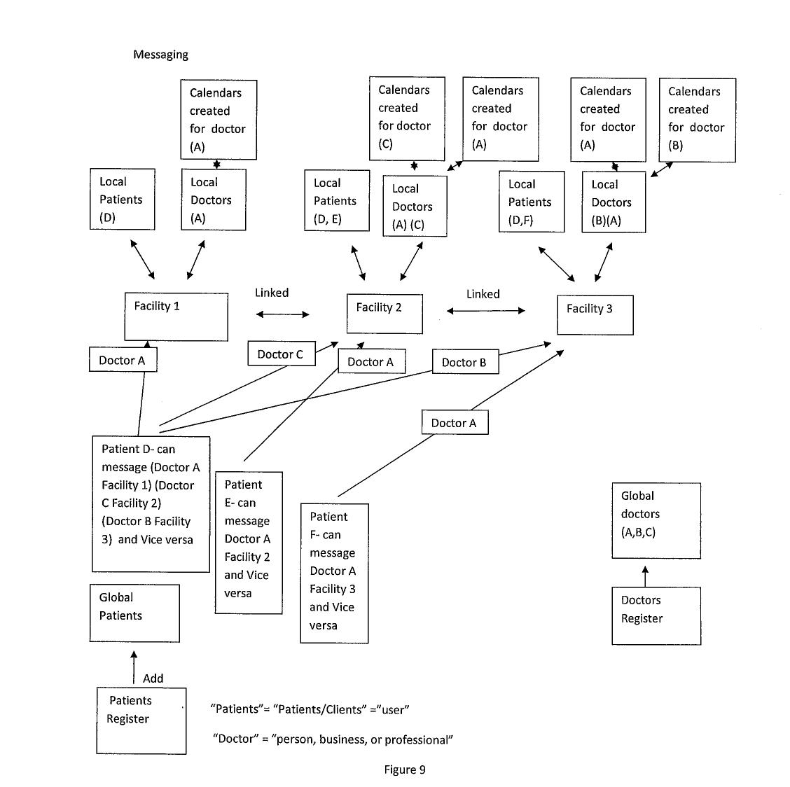

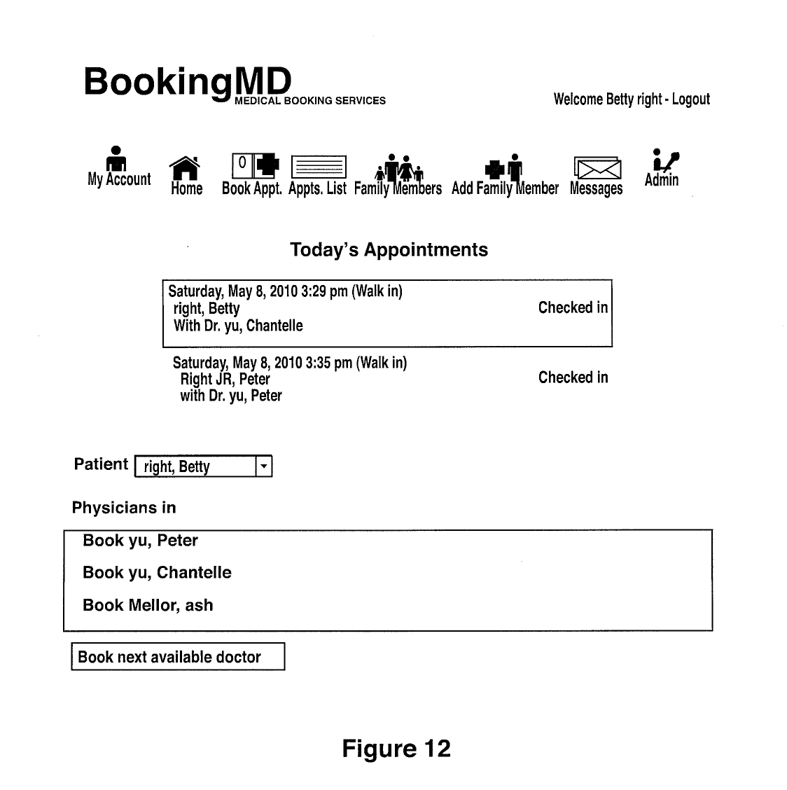

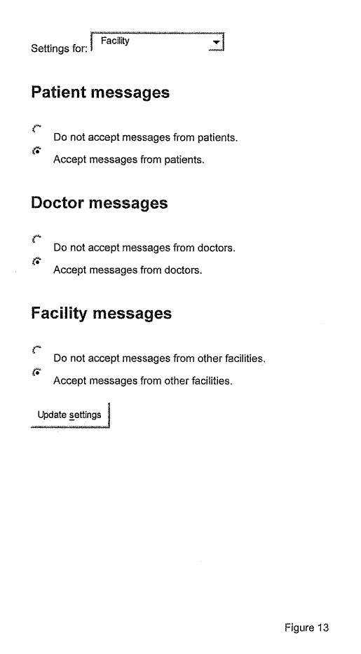

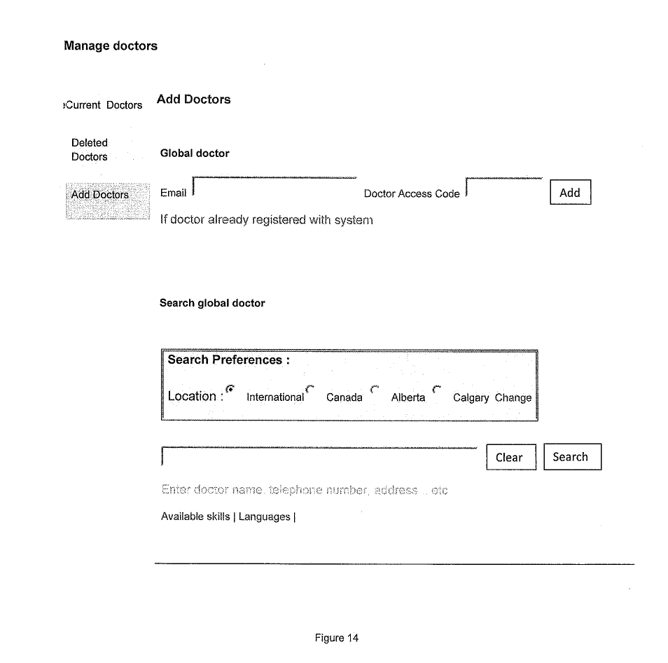

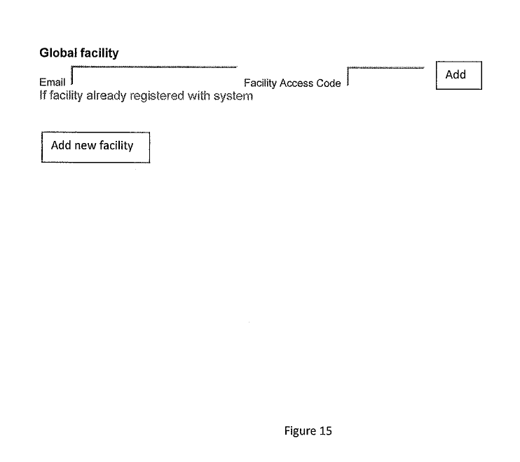

3. Walk in Clinic—FIG. 8:
Calendars can be set to take users on a walk in and first come first serve basis. It can also be set to be displayed or not be displayed on the patient kiosk's main page as shown in FIG. 10. A walk in basis calendar can be set to certain time basis when walk in appointment s are available. The person, business, professional or doctor in the clinic can choose to be displayed on the kiosk for patients to see whether or not he is available. When a patient/client (user) checks in with the receptionist or self check in with the kiosk, he can select to see a particular person, business, professional or doctor or be randomly assigned to see a person, business, professional or doctor working in the clinic at that time: Again this is all on a first come first serve basis. The clinic may select to give the patient/client (user) a numerical number so that the patient/client (user) knows his number in the waitlist queue as shown in FIG. 12.

4. Rebooking Appointments;
An appointment can be rebooked. Emails and texts are sent out to let users, person, business, professional and facility know of the changes. Reasons for the rebooking may be also included.

5. Cancelling Appointments:

An appointment can be cancelled. Emails and texts are sent out to let users, person, business, professional and facility know of the cancellation. Reasons for the cancellation may be also included and rebooking of appointment may be included.

6. Rejecting Appointments:
An appointment can be rejected. Emails and texts are sent out to let users, person, business, professional and facility know of the rejection. Reasons for the rejection may be also included and rebooking of appointment may be included.

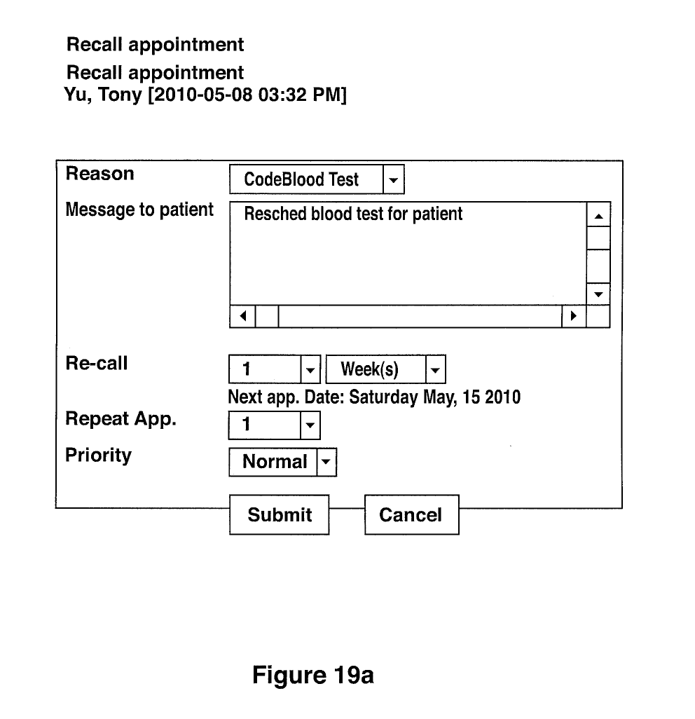

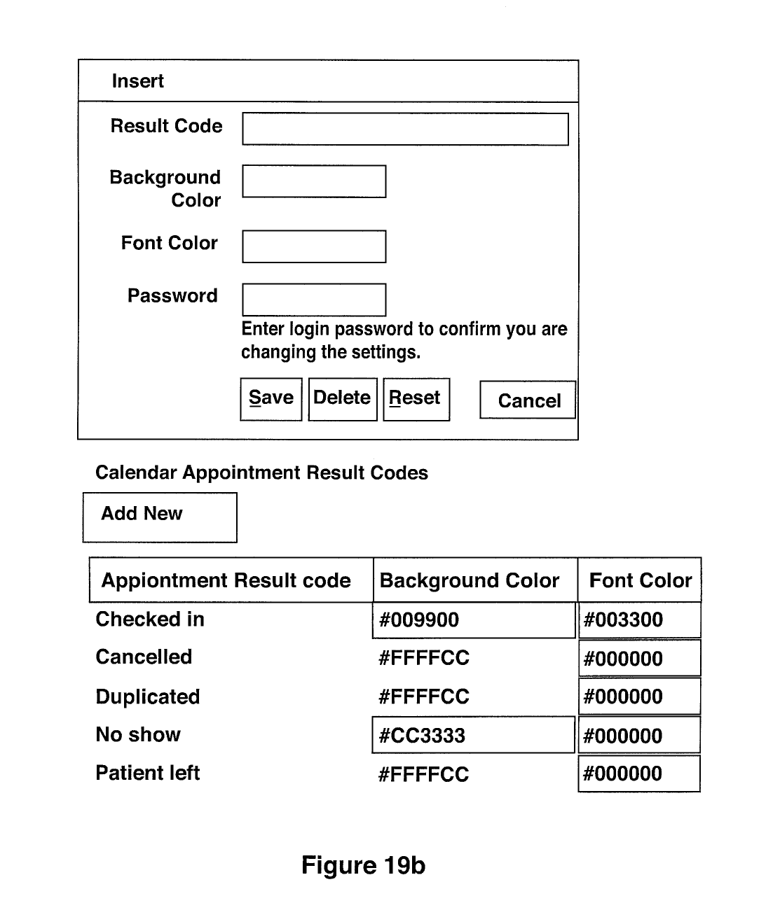

7. Results of Appointments—FIG. 19b:
Results from an appointment can be recorded as shown in FIG. 19b.

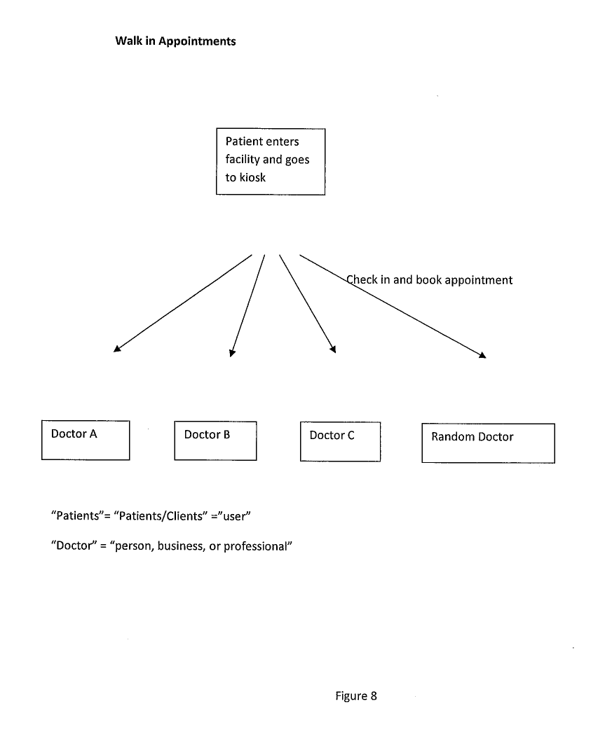

8. Check In—FIG. 7, 19b and 29:
When a patient arrives in the clinic for an appointment, the receptionist or the patient can check in with the time recorded.

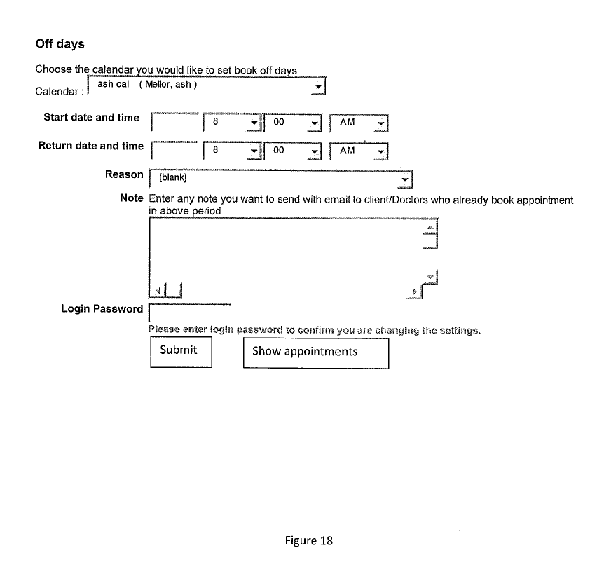

9. Book off Day—FIG. 18:
A period (date and time period) can be changed so that existing appointments are cancelled and available appointment time slots are made not available.
Emails and texts are sent out to let users, person, business, professional know of the cancellation. The time period that has been booked off can also be rebooked again.

10. Recall of Patient—FIG. 19a:
The patient/client (user) can be recalled for a return appointment in the future e.g. in one year's time. The facility can type in a new or preformed message for emailing or texting to the patient/client (user) to remind him of a recall appointment. This message will be sent at a predetermined time prior to the recall appointment time to tell the patient/client (user) of the recall appointment and for him to book the appointment. If an appointment exists within a certain time frame of the recall date, then a message will not be sent.

### Messages—FIGS. 9 & 13:

Messages can be sent by person, business, professional facility (clinic or business) or users.

A) Facility (Clinic or Business) Settings:
A facility (clinic or business) determines whether or not it will accept or not accept messages from users, person, business, or professional, or other facilities (clinics or businesses).

B) Person, Business, or Professional Settings:
A person, business, or professional determines whether or not it will accept or not accept messages from users, person, business, or professional, or other facilities (clinics or businesses).

C) Users Settings:
A user determines whether or not it will accept or not accept messages from users, person, business, or professional, or other facilities (clinics or businesses).

### Messages:

Messages can be sent from a message icon or it can be sent from a booked appointment in the calendar. If it is sent from a booked appointment in the calendar then the information regarding the sender, the receiver, the person, and the time of the appointment is inserted in the message automatically. Standard templates can be created for the description and used at another time. A printout in the form of a letter can be generated with the names of the referring person, referred to person and demographics of the user. Emails are generated to inform the user and facility of the messages.

### Referral and Consult Letters:

The referring and consult letters can be created at the messaging, calendar or booking appointment stage. The heading for the letter, the referring to, the referral from and who it is regarding can be automatically displayed and changed at any time. The salutation and the body of the letter can be typed new or stored as a template and used for another time. The appointment time and date of letter can be automatically displayed and changed at any time.

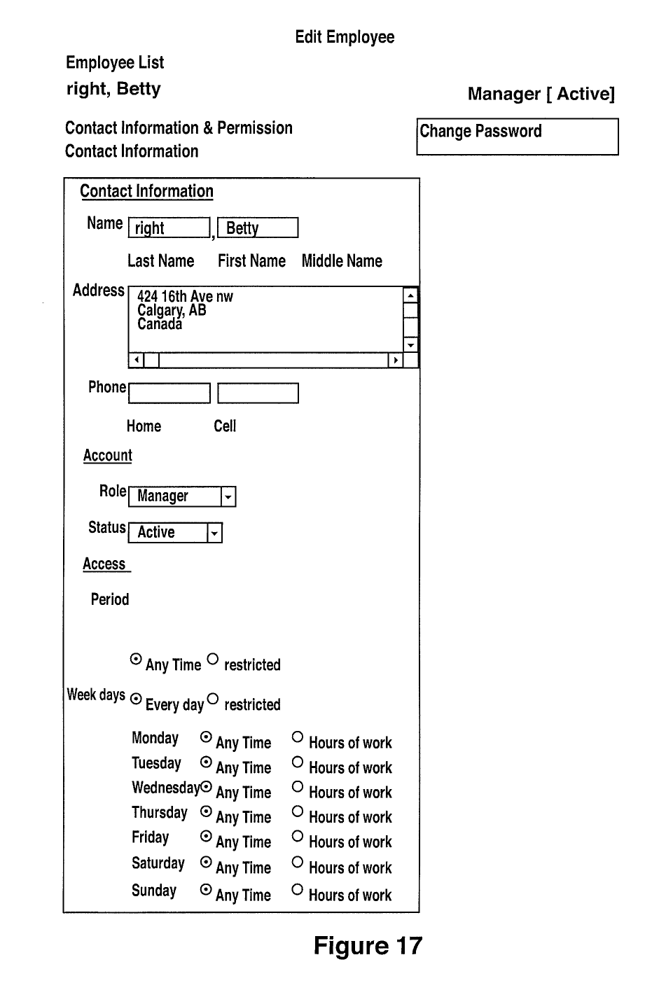

Staff Access (FIG. 17):

Staff can have various levels of access to the facility's account. Staff is designated whether he is a receptionist, manager or administrator. The administrator assigns the designations. A receptionist has certain level of access to the site, the manager has more access and the administrator has total access. The staff can sign into the facility with their email and a specific password assigned to them by the administrator. The staff access can be inactivated and activated at any time by the administrator. The staff's period and time of access can be assigned and changed by the administrator.

### Password and Access Code:

Password and access code can be changed at any time by the owner.

### Data:

Data from the online booking can be shared with and linked to other booking software by sharing data.

### Facility's Patient or Client (User) Kiosk (FIG. 11):

An icon exists on the facility's screen. A facility staff member first logs in with his email and assigned staff password. By clicking on the icon, the facility's patients or clients (users) kiosk screen appears as shown in FIG. 11. With this, a staff member can login into the facility and assign a computer where it is made available for use by the patient or client (user). This screen allows patients or clients (users) to login and check in. The computer allows patients or clients (users) to register, book an appointment, rebook an appointment. Once a patient or client (user) logins, It takes him to his page (FIG. 12).

The patient or client (user) cannot access the facility's information. The patient or client (user) can logout and returns the screen to the facility's patients or clients (users) access screen.

A staff member can log out of the facility's patients or clients (users) kiosk screen by entering his email and password.

Walk in appointments (FIG. 8):

A user can book an appointment on a walk in first come first serve basis by going to the location or facility of the business. The user can go to the facility's user access kiosk and register or login and then see the professionals who are taking appointments on a walk in basis. The user can book the appointment with a specific professional or be assigned to a random professional who is taking walk in users. The user can also choose to let the computer assign him to the first available professional as shown in FIG. 12.

The receptionist can also book an appointment for a user on a walk in basis. The receptionist can also record the result of the walk in appointment. That is, whether or not the user was seen, left or refused, etc.

We claim:

1. A computer implemented method for booking appointments on line, comprising:
a) generating a calendar identifying selected available appointment time periods;
b) registering a user on line, with selected profile identifiers for accessing said calendar; for booking an appointment.

2. A computer implemented method as claimed in claim 1 wherein said calendar is produced by a facility accessing on line instructions to produce a calendar with time periods so as to produce a calendar template having one or more of the following :
a) blocked time periods;
b) time periods requiring approval;
c) time periods not requiring approval; for making appointments.

3. A computer implemented method as claimed in claim 2 wherein said facility registers on line.

4. A computer implemented method as claimed in claim 3 wherein said facility is selected from the group of hospital, clinic, business, or kiosk.

5. A computer implemented method as claimed in claim 4 wherein a person, business, doctor or professional can be associated with more than one facility.

6. A computer implemented method as claimed in claim 5 wherein said user selected profile identifiers are stored in a global patient or client (user) data base.

7. A computer implemented method as claimed in claim 6 further providing a local patient or client (user) data base when the user books an appointment with a facility.

8. A computer implemented method as claimed in claim 7 wherein a user can be enrolled in more than one facility.

9. A computer implemented method as claimed in claim 8 wherein a user can add a family member.

10. A computer implemented method as claimed in claim 9 wherein a facility can register a user when an email for each user is the identifier for the user's global data base.

11. An on line booking system, comprising:
a) a server computer linked to the internet;
b) a server application linked to the server computer, the server application being operable to provide instructions to the server computer that:
i) receives profile information from a user for storage in global data base;
ii) permits registration by said user;
iii) receives profile information from a person, business or professional for storage in global data base;
iv) permits registration by said person, business or professional;
v) receives information from a facility;
vi) permits registration by the facility;
vii) permits the facility, person, business or professional to generate a calendar for appointment purposes;
vi) permits the registered user to access the calendar to make an appointment.

12. An on line booking system as claimed in claim 11 wherein said user is a patient or client (user) and the facility a hospital , business or clinic with persons, businesses, professionals or doctors.

13. An on line booking system as claimed in claim 11 wherein said user is a patient or client (user) and said facility is a hospital, business or clinic.

14. An on line booking system as claimed in claim 13 wherein said patient or client (user) accesses said server computer through the internet and receives confirmation of the appointment by email.

15. An online booking system as claimed in claim 14 wherein said hospital, business, clinic or kiosk accesses said server computer through the internet.

16. An on line booking system as claimed in claim 15 wherein a facility, doctor, person, business or professional accesses said server computer to produce a calendar that includes;
a) blocked time periods;
b) time periods requiring approval;
c) time periods not requiring approval;

17. An on line booking system as claimed in claim 16 wherein the patient or client (user) produces an on line account and profile stored in the server computer as a global patient or client (user) profile.

18. An on line booking system as claimed in claim 17 wherein the patient or client (user) produces a local patient or client (user) database when the patient or client (user) adds the patient's or client's (user's) global patient profile to a facilities list of local patients or clients (users).

19. An on line booking system as claimed in claim 18 wherein a person, business or professional produces an online account and profile stored in the server computer as a global person, business or professional profile.

20. An on line booking system as claimed in claim 19 wherein a facility produces an online account and profile stored in the server computer as a global facility profile.

21. An on line booking system as claimed in claim 20 wherein a person, business or professional can be linked to one or more facilities.

22. An on line booking system as claimed in claim 21 wherein a facility can add another facility linked together.

23. An on line booking system as claimed in claim 22, wherein a patient/client (user) can book appointments with different categories or types of businesses.

24. An on line booking system as claimed in claim 23 comprising a single centralized booking services for patients, clients, users, facilities, clinics, persons, businesses or professionals to make I appointments in a registered facility's , business's, clinic's, person's, professional's or doctor's office from anywhere in the world .
